(19) United States
(12) Patent Application Publication
(10) Pub. No.: US 2026/0322107 A1
(43) Pub. Date: Oct. 15, 2026

(54) IN-VEHICLE CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Takahiro KURATOMI, Yokkaichi-shi, Mie (JP); Takafumi KAWAKAMI, Yokkaichi-shi, Mie (JP); Yuki FUJIMURA, Osaka-shi, Osaka (JP); Tatsuya MANO, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/120,068

(22) PCT Filed: Jun. 6, 2023
(86) PCT No.: PCT/JP2023/021002

§ 371 Date: Apr. 10, 2025

(51) Int. Cl. H02H 7/22; B60R 16/023; B60R 16/033

(52) U.S. Cl. CPC H02H 7/22; B60R 16/0231; B60R 16/033

(57) ABSTRACT

An in-vehicle control device is included in an in-vehicle system provided with a power path through which power is supplied from a power source unit to a load, a relay provided on the power path, and an interruption unit provided on the power path. The in-vehicle control device includes a control unit that controls the interruption unit. The interruption unit switches from an allowable state in which supply of power from the power source unit side to the load side is allowed to an interruption state in which the supply of power is interrupted. When the value of current flowing through the relay exceeds a threshold value, the control unit switches the interruption unit to the interruption state based on the elapsed time from when the threshold value is exceeded and the current value after exceeding the threshold value.

### CROSS-REFERENCE TO RELATED APPLICATIONS

This application is the U.S. national stage of PCT/JP2023/021002 filed on Jun. 6, 2023, the contents of which are incorporated herein.

### TECHNICAL FIELD

The present disclosure relates to an in-vehicle control device.

### BACKGROUND

The background art of JP 2015-35951A discloses a load circuit that supplies power to a load. This load circuit is provided with a battery and a relay (semiconductor switch) provided between the battery and the load, and driving and stopping of the load is switched by the relay turning on and off.

When overcurrent continues to flow through a relay, an abnormality could occur such as the relay starting to smoke. In view of this, it is conceivable to prevent the occurrence of the above abnormality, by providing an interruption unit separate from the relay and interrupting the power path when current exceeding a threshold value continues to flow for a certain period of time. However, the time that it takes for the abnormality to occur changes according to the current value after exceeding the threshold value. It is thus desirable to interrupt the power path, taking into account the elapsed time from when the value of current flowing through the relay exceeds the threshold value and the current value after exceeding the threshold value.

An object of the present disclosure is to provide a technology capable of switching an interruption unit to an interruption state, taking into account the elapsed time from when the value of current flowing through a relay exceeds a threshold value and the current value after exceeding the threshold value.

### SUMMARY

An in-vehicle control device of the present disclosure is: An in-vehicle control device for inclusion in an in-vehicle system provided with a power path through which power is supplied from a power source unit to a load, a relay provided on the power path, and an interruption unit provided on the power path, the in-vehicle control device including: a control unit configured to control the interruption unit, the interruption unit being configured to switch from an allowable state in which supply of power from the power source unit side to the load side is allowed to an interruption state in which the supply of power is interrupted, and when a value of current flowing through the relay exceeds a threshold value, the control unit switching the interruption unit to the interruption state based on an elapsed time from when the threshold value is exceeded and the current value after exceeding the threshold value.

### Advantageous Effects

In a technology according to the present disclosure, an interruption unit can be switched to an interruption state, taking into account the elapsed time from when the value of current flowing through a relay exceeds a threshold value and the current value after exceeding the threshold value.

### BRIEF DESCRIPTION OF DRAWINGS

FIG. 1 is a block diagram schematically showing an in-vehicle system including an in-vehicle control device of the first embodiment.

FIG. 2 is an illustrative diagram showing graphs G1 and G2.

FIG. 3 is an illustrative diagram showing correspondence data DA.

FIG. 4 is an illustrative diagram showing correspondence data DB.

FIG. 5 is an illustrative diagram showing correspondence data DC.

FIG. 6 is an illustrative diagram showing TC-correspondence data DD.

FIG. 7 is a flowchart showing the flow of processing that is performed by a control unit.

### DETAILED DESCRIPTION OF PREFERRED EMBODIMENTS

Hereinafter, embodiments according to the present disclosure will be enumerated and illustrated.

In a first aspect, an in-vehicle control device for inclusion in an in-vehicle system provided with a power path through which power is supplied from a power source unit to a load, a relay provided on the power path, and an interruption unit provided on the power path, the in-vehicle control device including: a control unit configured to control the interruption unit, the interruption unit being configured to switch from an allowable state in which supply of power from the power source unit side to the load side is allowed to an interruption state in which the supply of power is interrupted, and when a value of current flowing through the relay exceeds a threshold value, the control unit switching the interruption unit to the interruption state based on an elapsed time from when the threshold value is exceeded and the current value after exceeding the threshold value.

The in-vehicle control device switches the interruption unit to the interruption state based on the elapsed time from when the value of current flowing through the relay exceeds the threshold value and the current value after exceeding the threshold value. That is, the in-vehicle control device is able to switch the interruption unit to the interruption state, taking into account the elapsed time from when the value of current flowing through the relay exceeds the threshold value and the current value after exceeding the threshold value.

In a second aspect, in the in-vehicle control device according to the first aspect, the threshold value may be a value smaller than a maximum rated current of a vehicle.

The in-vehicle control device is able to switch the interruption unit to the interruption state, when the value of current flowing through the relay exceeds a threshold value set to a value smaller than the maximum rated current of the vehicle.

In a third aspect, in the in-vehicle control device according to the first aspect, the threshold value may be a value smaller than a maximum interruptible current, which is a maximum current at which the relay is switchable from an ON state to an OFF state.

The in-vehicle control device is able to switch the interruption unit to the interruption state, when the value of current flowing through the relay exceeds a threshold value set to a value smaller than the maximum interruptible current.

In a fourth aspect, in the in-vehicle control device according to any one ofthe first through the third aspects, when the current value exceeds the threshold value, the control unit may determine whether a time integral value of the current value after exceeding the threshold value exceeds a corresponding value corresponding to the elapsed time, and, if it is determined that the corresponding value is exceeded, may switch the interruption unit to the interruption state.

The in-vehicle control device is able to switch the interruption unit to the interruption state, when the time integral value of the current value is accumulated to an extent exceeding the corresponding value corresponding to the elapsed time.

In a fifth aspect, in the in-vehicle control device according to any one of the first through the third aspects, when the current value exceeds the threshold value, the control unit may determine whether a time integral value of a square of the current value after exceeding the threshold value exceeds a corresponding value corresponding to the elapsed time, and, if it is determined that the corresponding value is exceeded, may switch the interruption unit to the interruption state.

The in-vehicle control device is able to switch the interruption unit to the interruption state, when the time integral value of the square of the current value is accumulated to an extent exceeding the corresponding value corresponding to the elapsed time.

In a sixth aspects, in the in-vehicle control device according to any one of the first through the fifth aspects, an interruption upper limit value larger than the threshold value and smaller than a maximum carriable current, which is a maximum current at which the relay is maintainable in the ON state, may be set in advance, and when the current value exceeds the interruption upper limit value, the control unit may switch the interruption unit to the interruption state regardless of the elapsed time.

The in-vehicle control device readily switches the interruption unit to the interruption state before the relay starts smoking or catches fire, by switching the interruption unit to the interruption state regardless of the elapsed time, when the value of current flowing through the relay exceeds the interruption upper limit value.

In a seventh aspect, in the in-vehicle control device according to the sixth aspect, the maximum carriable current may be smaller than a saturation current that flows through the power path when the power path is ground faulted, and the interruption upper limit value may be set such that the interruption unit switches to the interruption state before the current value reaches the saturation current, with consideration for a time lag from when it is determined that the current value exceeds the interruption upper limit value until when the interruption unit switches to the interruption state.

The in-vehicle control device is able to switch the interruption unit to the interruption state, before the value of current flowing through the relay reaches the saturation current.

In an eighth aspect, in the in-vehicle control device according to the sixth aspect, the interruption upper limit value may be set such that the interruption unit switches to the interruption state before the current value reaches the maximum carriable current, with consideration for a time lag from when it is determined that the current value exceeds the interruption upper limit value until when the interruption unit switches to the interruption state.

The in-vehicle control device is able to switch the interruption unit to the interruption state, before the value of current flowing through the relay reaches the maximum carriable current. Therefore, the in-vehicle control device is able to avoid a situation in which the relay is no longer able to maintain the ON state due to current exceeding the maximum carriable current flowing to the relay.

In a ninth aspect, in the in-vehicle control device according to any one of the first through the eighth aspects, the relay may be controlled by a second control unit different from the control unit, and, when it is determined that the second control unit has controlled the relay to be in the OFF state in a state where the current value exceeds the threshold value, the control unit may switch the interruption unit to the interruption state regardless of the elapsed time.

A situation is also envisioned in which the second control unit tries to switch the relay to the OFF state but the relay does not switch to the OFF state due to a relay malfunction or the like. Even if such a situation arises, the in-vehicle control device is able to reliably interrupt the current flowing through the power path, by switching the interruption unit to the interruption state, in the case where the second control unit has tried to switch the relay to the OFF state.

### First Embodiment

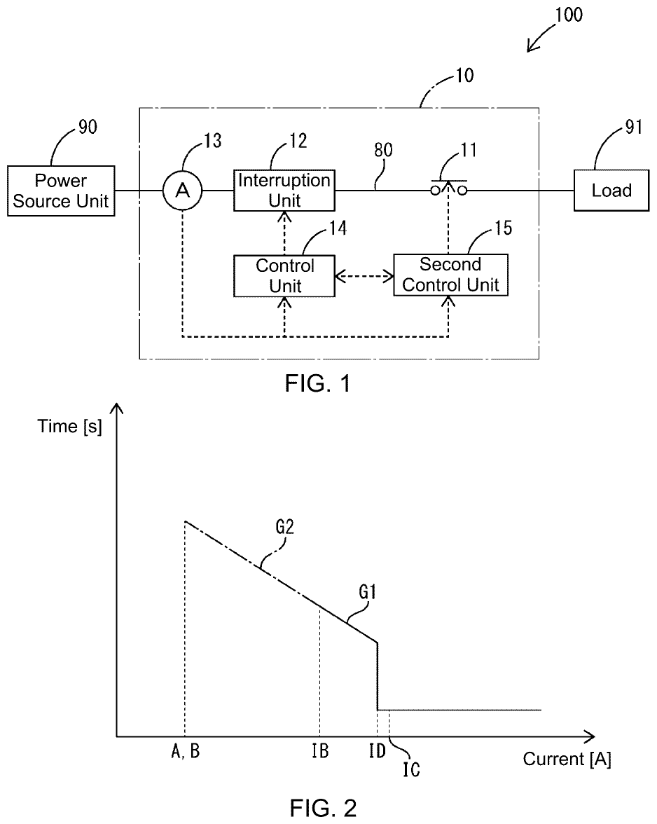

FIG. 1 shows an in-vehicle system 100 including an in-vehicle control device 10. The in-vehicle system 100 is a system installed in a vehicle. The in-vehicle system 100 includes a power source unit 90, a load 91, and a power path 80.

The power source unit 90 is, for example, a DC power source that produces a DC voltage, and is, for example, a battery. The battery is, for example, a lead battery or a lithium-ion battery. The load 91 is an electronic component provided in the vehicle. The load 91 is an electrical component, an ECU, or an ADAS-related component, for example. The power path 80 is provided between the power source unit 90 and the load 91. The power path 80 supplies power from the power source unit 90 to the load 91. One end of the power path 80 is electrically connected to the power source unit 90, and the other end is electrically connected to the load 91.

The in-vehicle control device 10 includes a relay 11, an interruption unit 12, a current detection unit 13, a control unit 14, and a second control unit 15.

The relay 11 is provided on the power path 80. When the relay 11 is in the ON state, current is carried between the power path 80 and the load 91. When the relay 11 is off, current is not carried between the power path 80 and the load 91. The relay 11 is controlled by the second control unit 15. In the present embodiment, the relay 11 is constituted as an electromagnetic relay and has contacts that operate by electromagnetic force.

The interruption unit 12 is provided on the power path 80. The interruption unit 12 switches from an allowable state in which supply of power from the power source unit 90 side to the load 91 side is allowed to an interruption state in which the supply of power is interrupted. The interruption unit 12 may be capable of returning to the allowable state after power supply is interrupted or may not be able to return after power supply is interrupted. The interruption unit 12 is constituted as, for example, a pyrotechnic circuit breaker, a semiconductor switch, or an electromagnetic fuse. A pyrotechnic circuit breaker is a circuit breaker that physically disconnects the power path 80 in response to input of a drive signal, and is, for example, a Pyrofuse (registered trademark). The interruption unit 12 is controlled by the control unit 14.

The current detection unit 13 is constituted as, for example, a known current sensor. The current detection unit 13 detects current flowing through the relay 11. The current detection unit 13 outputs a signal capable of specifying a detection value. This signal is input to both the control unit 14 and the second control unit 15.

The control unit 14 controls the interruption unit 12. The control unit 14 is constituted as, for example, an MCU (Micro-Controller Unit). The control unit 14 is constituted as a separate device from the second control unit 15. The control unit 14 detects the value of current flowing through the relay 11 based on the signal output by the current detection unit 13.

When the value of current flowing through the relay 11 exceeds a threshold value A, the control unit 14 switches the interruption unit 12 to the interruption state based on an elapsed time EA from when the threshold value A is exceeded and the current value after exceeding the threshold value A. The threshold value A is a value smaller than a maximum rated current IA of the vehicle. For example, a battery management system that manages the power source unit 90 (specifically, battery) treats current exceeding the maximum rated current IA as an overflow. For example, the battery management system treats the current at the time that the maximum rated current IA is exceeded as the maximum rated current IA, in the SoC (State of Charge) calculation or the like. For example, the current consumption of the load 91 is restricted so as not to exceed the maximum rated current IA.

When the value of current flowing through the relay 11 exceeds the threshold value A, the control unit 14 determines whether a time integral value ZA of the current value after exceeding the threshold value A exceeds a corresponding value CA corresponding to the elapsed time EA, and, if it is determined that the corresponding value CA is exceeded, switches the interruption unit 12 to the interruption state. Correspondence data DA indicating the correspondence relationship between the elapsed time EA and the corresponding value CA is stored in advance in the control unit 14. The correspondence data DA may be a function indicating the correspondence relationship between the elapsed time EA and the corresponding value CA, or may be table data indicating the correspondence relationship between the elapsed time EA and the corresponding value CA. The correspondence data DA is set to have the interruption characteristics shown by graph G1 in FIG. 2. Graph G1 shows, for each current value in a predetermined current value range, the time until the power path is interrupted in the case where current having that current value continues to flow. Graph G1 indicates the characteristic that the time until the power path is interrupted becomes shorter as the current value increases.

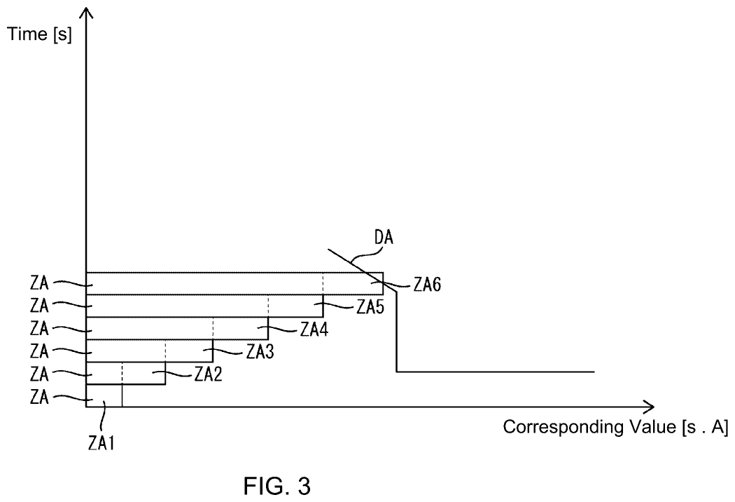

When the value of current flowing through the relay 11 exceeds the threshold value A, the control unit 14 repeatedly calculates the time integral value ZA of the current value after exceeding the threshold value A. For example, the control unit 14 first calculates ZA1 as the time integral value ZA, as shown in FIG. 3. In the next cycle, the control unit 14 adds ZA2 to the time integral value ZA calculated in the previous cycle to obtain a new time integral value ZA. By repeating such processing, the control unit 14 repeatedly calculates the time integral value ZA. The control unit 14 derives the corresponding value CA corresponding to the elapsed time EA, using the correspondence data DA. The control unit 14 repeatedly determines whether the time integral value ZA exceeds the corresponding value CA. In the example shown in FIG. 3, the time integral value ZA of the sixth cycle to which ZA6 is added exceeds the corresponding value CA. When it is determined that the time integral value ZA exceeds the corresponding value CA, the control unit 14 switches the interruption unit 12 to the interruption state.

Note that the time integral value ZA may be reset to 0, when a first reset condition is established. The first reset condition may be that a certain amount of time has elapsed from when the value of current flowing through the relay 11 exceeds the threshold value A, or that the value of current flowing through the relay 11 has fallen to less than the threshold value A, or may be another condition.

When the value of current flowing through the relay 11 exceeds a threshold value B, the control unit 14 switches the interruption unit 12 to the interruption state based on the elapsed time from when the threshold value B is exceeded and the current value after exceeding the threshold value B. The threshold value B is a value smaller than a maximum interruptible current IB. In the present embodiment, the threshold value B is the same as the threshold value A, but may be larger than the threshold value A or smaller than the threshold value A. The maximum interruptible current IB is the maximum current at which the relay 11 is switchable from the ON state to the OFF state.

When the value of current flowing through the relay 11 exceeds the threshold value B, the control unit 14 determines whether the time integral value ZB of the current value after exceeding the threshold value B exceeds a corresponding value CB corresponding to an elapsed time EB, and, if it is determined that the corresponding value CB is exceeded, switches the interruption unit 12 to the interruption state. Correspondence data DB indicating the correspondence relationship between the elapsed time EB and the corresponding value CB is stored in advance in the control unit 14. The correspondence data DB may be a function indicating the correspondence relationship between the elapsed time EB and the corresponding value CB, or may be table data indicating the correspondence relationship between the elapsed time EB and the corresponding value CB. The correspondence data DB is set to have the interruption characteristics shown by graph G1 in FIG. 2.

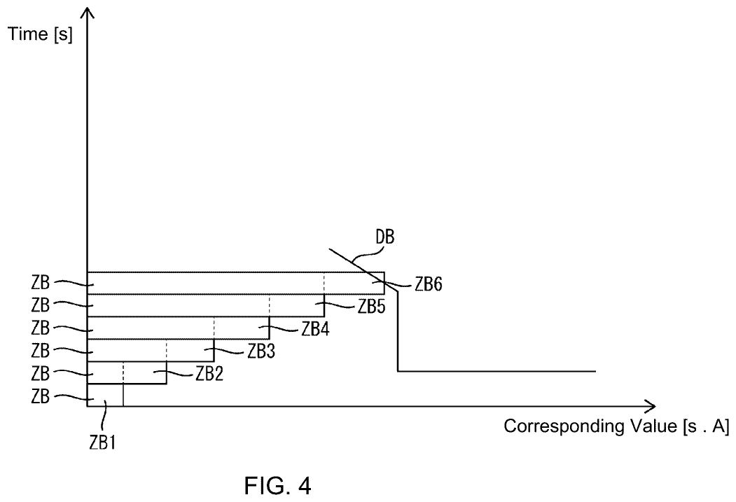

When the value of current flowing through the relay 11 exceeds the threshold value B, the control unit 14 repeatedly calculates the time integral value ZB of the current value after exceeding the threshold value B. For example, the control unit 14 first calculates ZB1 as the time integral value ZB, as shown in FIG. 4. In the next cycle, the control unit 14 adds ZB2 to the time integral value ZB calculated in the previous cycle to obtain a new time integral value ZB. By repeating such processing, the control unit 14 repeatedly calculates the time integral value ZB. The control unit 14 derives the corresponding value CB corresponding to the elapsed time EB, using the correspondence data DB. The control unit 14 repeatedly determines whether the time integral value ZB exceeds the corresponding value CB. In the example shown in FIG. 4, the time integral value ZB of the sixth cycle to which ZB6 is added exceeds the corresponding value CB. When it is determined that the time integral value ZB exceeds the corresponding value CB, the control unit 14 switches the interruption unit 12 to the interruption state.

Note that the time integral value ZB may be reset to 0, when a second reset condition is established. The second reset condition may be that a certain amount of time has elapsed from when the value of current flowing through the relay 11 exceeds the threshold value B, or that the value of current flowing through the relay 11 has fallen to less than the threshold value B, or may be another condition.

The second control unit 15 controls the relay 11. The second control unit 15 is constituted as, for example, an MCU (Micro-Controller Unit). The second control unit 15 is constituted as a separate device from the control unit 14. The second control unit 15 switches the relay 11 to the ON state, when a starting condition determined in advance is established. The starting condition is that the starting switch of the vehicle is switched to the ON state, for example. The starting switch is, for example, the ignition switch of an engine-powered vehicle, or the power switch of an electric vehicle. The second control unit 15 recognizes the ON/OFF state of the starting switch of the vehicle by, for example, receiving a signal indicating the ON/OFF state of the starting switch. The second control unit 15 switches the relay 11 to the OFF state, when a stopping condition determined in advance is established. The stopping condition is that the starting switch of the vehicle is switched to the OFF state, for example. The second control unit 15 switches the relay 11 to the OFF state, when an interruption condition determined in advance is established. The interruption condition is a condition that can be established based on, for example, the value of current flowing through the relay 11. The condition that can be established based on the value of current flowing through the relay 11 is a condition that the value of current flowing through the relay 11 exceeds a reference value, for example. The second control unit 15 detects the value of current flowing through the relay 11 based on the signal output by the current detection unit 13.

When the value of current flowing through the relay 11 exceeds the reference value, the second control unit 15 switches the relay 11 to the OFF state based on an elapsed time EC from when the reference value is exceeded and the current value after exceeding the reference value.

When the value of current flowing through the relay 11 exceeds the reference value, the second control unit 15 determines whether a time integral value ZC of the current value after exceeding the reference value exceeds a corresponding value CC corresponding to the elapsed time EC, and, if it is determined that the corresponding value CC is exceeded, switches the relay 11 to the OFF state. Correspondence data DC indicating the correspondence relationship between the elapsed time EC and the corresponding value CC is stored in advance in the second control unit 15. The correspondence data DC may be a function indicating the correspondence relationship between the elapsed time EC and the corresponding value CC, or may be table data indicating the correspondence relationship between the elapsed time EC and the corresponding value CC. The correspondence data DC is set to have the interruption characteristics shown by graph G2 in FIG. 2. Graph G2 shows, for each current value in a predetermined current value range (specifically, current value range smaller than lower limit value of current value range of graph G1), the time until the power path is interrupted when current of that current value continues to flow. Graph G2 shows the characteristic that the time until the power path is interrupted becomes shorter as the current value increases.

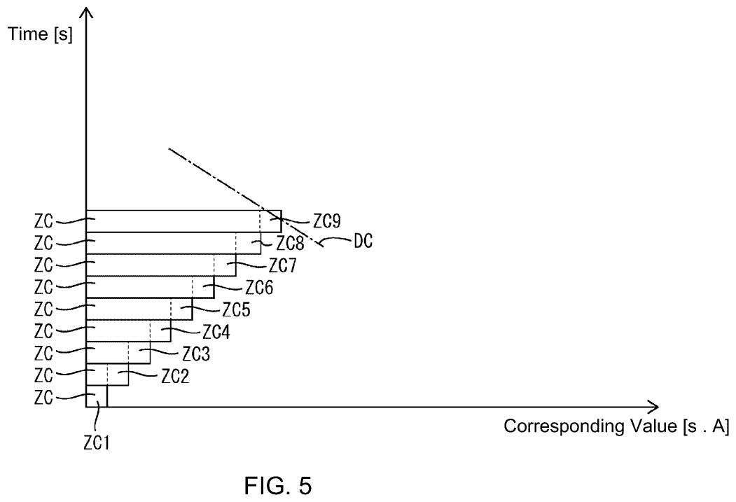

When the value of current flowing through the relay 11 exceeds the reference value, the second control unit 15 repeatedly calculates the time integral value ZC of the current value after exceeding the reference value. For example, the second control unit 15 first calculates ZC1 as the time integral value ZC, as shown in FIG. 5. In the next cycle, the second control unit 15 adds ZC2 to the time integral value ZC calculated in the previous cycle to obtain a new time integral value ZC. By repeating such processing, the second control unit 15 repeatedly calculates the time integral value ZC. The second control unit 15 derives the corresponding value CC corresponding to the elapsed time EC, using the correspondence data DC. The second control unit 15 repeatedly determines whether the time integral value ZC exceeds the corresponding value CC. In the example shown in FIG. 5, the time integral value ZC of the ninth cycle to which ZC9 is added exceeds the corresponding value CC. The second control unit 15 switches the interruption unit 12 to the interruption state when it is determined that the time integral value ZC exceeds the corresponding value CC.

Note that the time integral value ZC may be reset to 0, when a third reset condition is established. The third reset condition may be that a certain amount of time has elapsed from when the value of current flowing through the relay 11 exceeds the reference value, or that the value of current flowing through the relay 11 has fallen to less than the reference value, or may be another condition.

When the value of current flowing through the relay 11 exceeds an interruption upper limit value ID set in advance, the control unit 14 switches the interruption unit 12 to the interruption state regardless of the elapsed times EA and EB described above. The interruption upper limit value ID is larger than the threshold values A and B. The interruption upper limit value ID is larger than the maximum interruptible current IB. The interruption upper limit value ID is smaller than a maximum carriable current IC. The maximum carriable current IC is the maximum current at which the relay 11 can maintain the ON state. The relay 11 is an electromagnetic relay, as described above. When current flows to an electromagnetic relay, an electromagnetic repulsive force occurs in the electromagnetic relay so as to change the electromagnetic relay from the ON state to the OFF state. This electromagnetic repulsive force increases in response to an increase in the magnitude of current flowing to the electromagnetic relay. When the current flowing to the electromagnetic relay becomes larger than the maximum carriable current IC, the electromagnetic repulsive force becomes larger than the force that maintains the electromagnetic relay in the ON state, and the electromagnetic relay changes to the OFF state. In a state where the electromagnetic relay has been changed to the OFF state, an arc could possibly occur within the electromagnetic relay and cause the electromagnetic relay to malfunction. Thus, when the value of current flowing through the relay 11 exceeds the interruption upper limit value ID, which is set to a value smaller than the maximum carriable current IC, the control unit 14 switches the interruption unit 12 to the interruption state regardless of the elapsed times EA and EB described above.

The maximum carriable current IC described above is smaller than a saturation current IS that flows through the power path 80 when the power path 80 is ground faulted. The saturation current IS is, for example, the saturation current in the case where it is assumed that the path between the relay 11 and the load 91 is ground faulted when the power source unit 90 is fully charged in a state where the in-vehicle system 100 has not deteriorated. The interruption upper limit value ID is set such that the interruption unit 12 switches to the interruption state before the value of current flowing through the relay 11 reaches the saturation current IS, with consideration for a time lag TL from when it is determined that the value of current flowing through the relay 11 exceeds the interruption upper limit value ID until when the interruption unit 12 switches to the interruption state.

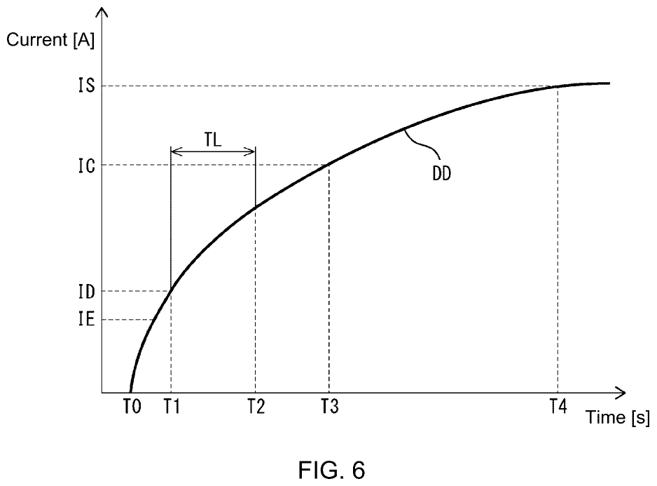

The interruption upper limit value ID is set based on, for example, the time lag TL and TC-correspondence data DD (see FIG. 6) indicating the correspondence relationship between the elapsed time from when the ground fault occurred and the value of current flowing through the relay 11.

The time lag TL arises due to the time from when the control unit 14 determines that the interruption upper limit value ID is exceeded until when the control for switching the interruption unit 12 to the interruption state is started, and the time when from the control for switching the interruption unit 12 to the interruption state is started until when the interruption unit 12 switches to the interruption state. The time lag TL can be obtained from, for example, test results or simulation results.

The TC-correspondence data DD can be obtained from, for example, test results or simulation results. The test results or simulation results are results obtained when the path between the relay 11 and the load 91 is ground faulted, in a state where the in-vehicle system 100 has not deteriorated and the power source unit 90 is fully charged, for example.

In the TC-correspondence data DD shown in FIG. 6, timing T0 is the timing at which the ground fault occurs. Thereafter, the current value gradually increases with the elapse of time. Timing T4 is the timing at which the value of current flowing through the relay 11 reaches the saturation current IS.

The timing at which it is determined that the value of current flowing through the relay 11 has reached the saturation current IS may, for example, be the timing at which the elapsed time from when the ground fault occurs is three times a time constant τ, or the timing at which 1 ms has elapsed from when the ground fault occurs. The time constant τis calculated by the following equation (1), for example.

$$Time constant τ = ( L 1 + L 2 + L 3 ) / ( R 1 + R 2 + R 3 ) \qquad ( 1 )$$

L1 is the internal inductance of the power source unit 90. L2 is the inductance of the path between the power source unit 90 and the ground fault location on the power path 80. L3 is the inductance of the ground fault location.

R1 is the internal resistance value of the power source unit 90. R2 is the resistance value of the path between the power source unit 90 and the ground fault location on the power path 80. R3 is the resistance value at the ground fault location. Note that L3 and R3 can change depending on the way in which the ground fault occurs, and may thus be set to 0, for example.

For example, the current value corresponding to timing T1 from which timing T4 is not reached even taking into consideration the time lag TL is set as the interruption upper limit value ID. That is, timing T1, which is a timing at which timing T2 after the time lag TL has elapsed is earlier than timing T4, is specified and the current value corresponding to this timing T1 is set as the interruption upper limit value ID.

The interruption upper limit value ID is set such that the interruption unit 12 switches to the interruption state before the value of current flowing through the relay 11 reaches the maximum carriable current IC, with consideration for the time lag TL until the interruption unit 12 switches to the interruption state after it is determined that value of current flowing through the relay 11 exceeds the interruption upper limit value ID. The interruption upper limit value ID is set based on, for example, the time lag TL and the TC-correspondence data DD.

In the TC-correspondence data DD shown in FIG. 6, the timing at which the value of current flowing through the relay 11 reaches the maximum carriable current IC is timing T3. For example, the current value corresponding to timing T1 from which timing T3 is not reached even taking into consideration the time lag TL is set as the interruption upper limit value ID. That is, timing T1, which is the timing at which timing T2 after the time lag TL has elapsed is earlier than timing T3 is specified, and the current value corresponding to this timing T1 is set as the interruption upper limit value ID.

In the normal state of the power path 80, the interruption upper limit value ID is set to a value larger than a maximum current value IE flowable through the power path 80. The normal state of the power path 80 is a state in which the power path 80 is not ground faulted, and, more specifically, is a state in which the voltage value of the power path 80 is greater than or equal to a threshold voltage. The threshold voltage is a value greater than or equal to 0 V or more. The maximum current value IE flowable through the power path 80 is, for example, the current that flows through the power path 80 when a load 91 such as a motor of the vehicle is operated to the maximum when the power source unit 90 is fully charged.

If it is determined that the second control unit 15 has controlled the relay 11 to be in the OFF state in a state where the current value flowing through the relay 11 exceeds the threshold value A, the control unit 14 switches the interruption unit 12 to the interruption state regardless of the elapsed time EA. If it is determined that the second control unit 15 has controlled the relay 11 to be in the OFF state in a state where the value of current flowing through the relay 11 exceeds the threshold value B, the control unit 14 switches the interruption unit 12 to the interruption state regardless of the elapsed time EB. The second control unit 15 outputs, for example, a control signal for controlling the relay 11 to be in the OFF state, and outputs a notification signal to the control unit 14. The control unit 14 determines that the second control unit 15 has controlled the relay 11 to be in the OFF state, due to receiving the notification signal.

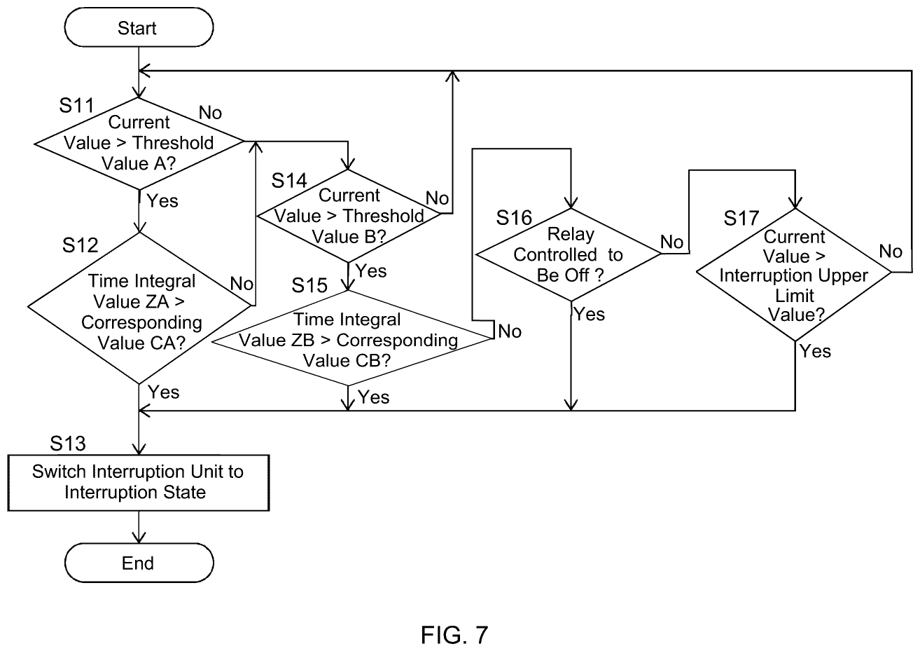

The control unit 14 performs the processing shown in FIG. 7, following the starting switch of the vehicle being switched to the OFF state, for example. In step S11, the control unit 14 determines whether the value of current flowing through the relay 11 is larger than the threshold value A. If it is determined that the value of current flowing through the relay 11 is not larger than the threshold value A, the control unit 14, in step S14, determines whether the value of current flowing through the relay 11 is larger than the threshold value B. If it is determined that the value of current flowing through the relay 11 is not larger than the threshold value B, the control unit 14 returns to step S11. In a state where the value of current flowing through the relay 11 is normal, the control unit 14 repeats the processing of steps S11 and S14.

When a ground fault occurs between the relay 11 and the load 91, for example, the value of current flowing through the relay 11 increases. If it is determined that the value of current flowing through the relay 11 is larger than the threshold value A in step S11, the control unit 14 starts calculating the time integral value ZA and transitions to step S12. Note that when the time integral value ZA is already being calculated, the control unit 14 continues calculating the time integral value ZA. In step S12, the control unit 14 determines whether the time integral value ZA is larger than the corresponding value CA corresponding to the time integral value ZA. If it is determined that the time integral value ZA is larger than the corresponding value CA, the control unit 14, in step S13, switches the interruption unit 12 to the interruption state. If it is determined that the time integral value ZA is not larger than the corresponding value CA, the control unit 14 transitions to step S14.

When it is determined in step S14 that the value of current flowing through the relay 11 is larger than the threshold value B, the control unit 14 starts calculating the time integral value ZB and transitions to step S15. Note that when the time integral value ZB is already being calculated, the control unit 14 continues calculating the time integral value ZB. In step S15, the control unit 14 determines whether the time integral value ZB is larger than the corresponding value CB corresponding to the time integral value ZB. If it is determined that the time integral value ZB is not larger than the corresponding value CB, the control unit 14, in step S16, it determines whether the control unit 14 has controlled the relay 11 to be in the OFF state. If it is determined that the control unit 14 has not controlled the relay 11 to be in the OFF state, the control unit 14, in step S17, determines whether the value of current flowing through the relay 11 is larger than the interruption upper limit value ID. If it is determined that the value of current flowing through the relay 11 is not larger than the interruption upper limit value ID, the control unit 14 returns to step S11. That is, the control unit 14 repeats the processing of steps S14, S15, S16, and S17 when the value of current flowing through the relay 11 exceeds the threshold value B.

When it is determined in step S15 that the time integral value ZB is larger than the corresponding value CB, the control unit 14, in step S13, switches the interruption unit 12 to the interruption state. If it is determined in step S16 that the control unit 14 has controlled the relay 11 to be in the OFF state, the control unit 14, in step S13, switches the interruption unit 12 to the interruption state. If it is determined in step S17 that the value of current flowing through the relay 11 is larger than the interruption upper limit value ID, the control unit 14, in step S13, switches the interruption unit 12 to the interruption state.

The following description relates to the effects of the in-vehicle control device 10. The in-vehicle control device 10 switches the interruption unit 12 to the interruption state based on the elapsed time EA from when the value of current flowing through the relay 11 exceeds the threshold value A and the current value after exceeding the threshold value A. That is, the in-vehicle control device 10 is able to switch the interruption unit 12 to the interruption state, taking into account the elapsed time EA from when the value of current flowing through the relay 11 exceeds the threshold value A and the current value after exceeding the threshold value A. Also, the in-vehicle control device 10 is able to switch the interruption unit 12 to the interruption state, when the time integral value ZA of the current value is accumulated to an extent exceeding the corresponding value CA corresponding to the elapsed time EA.

The in-vehicle control device 10 switches the interruption unit 12 to the interruption state based on the elapsed time EB from when the value of current flowing through the relay 11 exceeds the threshold value B and the current value after exceeding the threshold value B. That is, the in-vehicle control device 10 is able to switch the interruption unit 12 to the interruption state, taking into account the elapsed time EB from when the value of current flowing through the relay 11 exceeds the threshold value B and the current value after exceeding the threshold value B. Also, the in-vehicle control device 10 is able to switch the interruption unit 12 to the interruption state, when the time integral value ZB of the current value is accumulated to an extent exceeding the corresponding value CB corresponding to the elapsed time EB.

By switching the interruption unit 12 to the interruption state regardless of the elapsed time EB in the case where the value of current flowing through the relay 11 exceeds the interruption upper limit value ID, the in-vehicle control device 10 readily switches the interruption unit 12 to the interruption state before the relay 11 becomes unable to maintain the ON state.

The in-vehicle control device 10 is able to switch the interruption unit 12 to the interruption state, before the value of current flowing through the relay 11 reaches the saturation current IS.

The in-vehicle control device 10 is able to switch the interruption unit 12 to the interruption state, before the value of current flowing through the relay 11 reaches the maximum carriable current IC. Therefore, the in-vehicle control device 10 is able to avoid a situation in which the relay 11 becomes unable to maintain the ON state due to current exceeding the maximum carriable current IC flowing to the relay 11.

A situation is also envisioned in which the second control unit 15 tries to switch the relay 11 to the OFF state based on the elapsed time EC and the current value but the relay 11 does not switch to the OFF state due to a malfunction of the relay 11 or the like. Even if such a situation arises, the in-vehicle control device 10 is able to reliably interrupt the current flowing through the power path 80, by switching the interruption unit 12 to the interruption state, in the case where the second control unit 15 has tried to switch the relay 11 to the OFF state.

### Other Embodiments

The present disclosure is not limited to the embodiment illustrated in the above description and drawings. For example, features of the above-described or later-described embodiments can be combined in any way as long as no inconsistencies arise. Also, any of the features of the above-described or later-described embodiments can be omitted if not specified as essential. Furthermore, the above-described embodiment may be modified as follows.

In the above embodiment, a configuration is adopted in which, when the value of current flowing through the relay 11 exceeds the threshold value A, the control unit 14 determines whether the time integral value ZA of the current value after exceeding the threshold value A exceeds the corresponding value CA corresponding to the elapsed time EA, and switches the interruption unit 12 to the interruption state if it is determined that the corresponding value CA is exceeded. Alternatively, a configuration may be adopted in which, when the value of current flowing through the relay 11 exceeds the threshold value A, the control unit 14 determines whether the time integral value of the square of the current value after exceeding the threshold value A exceeds the corresponding value corresponding to the elapsed time EA, and switches the interruption unit 12 to the interruption state if it is determined that the corresponding value is exceeded. In this case, the in-vehicle control device is able to switch the interruption unit 12 to the interruption state, when the time integral value of the square of the current value is accumulated to an extent exceeding the corresponding value corresponding to the elapsed time EA.

In the above embodiment, a configuration is adopted in which, when the value of current flowing through the relay 11 exceeds the threshold value B, the control unit 14 determines whether the time integral value ZA of the current value after exceeding the threshold value B exceeds the corresponding value CB corresponding to the elapsed time EB, and switches the interruption unit 12 to the interruption state if it is determined that the corresponding value CB is exceeded. Alternatively, a configuration may be adopted in which, when the value of current flowing through the relay 11 exceeds the threshold value B, the control unit 14 determines whether the time integral value of the square of the current value after exceeding the threshold value B exceeds the corresponding value corresponding to the elapsed time EB, and switches the interruption unit 12 to the interruption state if it is determined that the corresponding value is exceeded. In this case, the in-vehicle control device is able to switch the interruption unit 12 to the interruption state, when the time integral value of the square of the current value is accumulated to an extent exceeding the corresponding value corresponding to the elapsed time EB.

The interruption upper limit value need not be set. That is, the processing of step S16 in FIG. 7 may be omitted.

One of the threshold value A and the threshold value B may be omitted. That is, either steps S11 and S12 or steps S14 and S15 in FIG. 7 may be omitted.

In the above embodiment, the interruption upper limit value ID is larger than the maximum interruptible current IB, but may be smaller than the maximum interruptible current IB.

A fuse may be provided between the power source unit 90 and the current detection unit 13.

Note that the embodiments disclosed herein are to be considered in all respects as exemplary and not restrictive. The scope of the present disclosure is not limited to the embodiments disclosed herein, and all changes that come within the meaning and range of equivalency of the claims are intended to be embraced therein.

1. An in-vehicle control device for inclusion in an in-vehicle system provided with a power path through which power is supplied from a power source unit to a load, a relay provided on the power path, and an interruption unit provided on the power path, the in-vehicle control device comprising:
a control unit configured to control the interruption unit,
wherein the interruption unit is configured to switch from an allowable state in which supply of power from the power source unit side to the load side is allowed to an interruption state in which the supply of power is interrupted,
when a value of current flowing through the relay exceeds a threshold value, the control unit switches the interruption unit to the interruption state based on an elapsed time from when the threshold value is exceeded and the current value after exceeding the threshold value, and
the threshold value is a value smaller than a maximum interruptible current, which is a maximum current at which the relay is switchable from an ON state to an OFF state.

2. (canceled)

3. An in-vehicle control device for inclusion in an in-vehicle system provided with a power path through which power is supplied from a power source unit to a load, a relay provided on the power path, and an interruption unit provided on the power path, the in-vehicle control device comprising:
a control unit configured to control the interruption unit,
wherein the interruption unit is configured to switch from an allowable state in which supply of power from the power source unit side to the load side is allowed to an interruption state in which the supply of power is interrupted,
when a value of current flowing through the relay exceeds a threshold value, the control unit switches the interruption unit to the interruption state based on an elapsed time from when the threshold value is exceeded and the current value after exceeding the threshold value, and
when the current value exceeds the threshold value, the control unit determines whether a time integral value of a square of the current value after exceeding the threshold value exceeds a corresponding value corresponding to the elapsed time, and, if it is determined that the corresponding value is exceeded, switches the interruption unit to the interruption state.

4. An in-vehicle control device for inclusion in an in-vehicle system provided with a power path through which power is supplied from a power source unit to a load, a relay provided on the power path, and an interruption unit provided on the power path, the in-vehicle control device comprising:
a control unit configured to control the interruption unit,
wherein the interruption unit is configured to switch from an allowable state in which supply of power from the power source unit side to the load side is allowed to an interruption state in which the supply of power is interrupted,
when a value of current flowing through the relay exceeds a threshold value, the control unit switches the interruption unit to the interruption state based on an elapsed time from when the threshold value is exceeded and the current value after exceeding the threshold value,
an interruption upper limit value larger than the threshold value and smaller than a maximum carriable current, which is a maximum current at which the relay is maintainable in the ON state, is set in advance, and
when the current value exceeds the interruption upper limit value, the control unit switches the interruption unit to the interruption state regardless of the elapsed time.

5. The in-vehicle control device according to claim 4,
wherein the maximum carriable current is smaller than a saturation current that flows through the power path when the power path is ground-faulted, and
the interruption upper limit value is set such that the interruption unit switches to the interruption state before the current value reaches the saturation current, with consideration for a time lag from when it is determined that the current value exceeds the interruption upper limit value until when the interruption unit switches to the interruption state.

6. The in-vehicle control device according to claim 4, wherein the interruption upper limit value is set such that the interruption unit switches to the interruption state before the current value reaches the maximum carriable current, with consideration for a time lag from when it is determined that the current value exceeds the interruption upper limit value until when the interruption unit switches to the interruption state.

7. (canceled)

8. (canceled)

9. (canceled)
